(19) United States
(12) Patent Application Publication
(10) Pub. No.: US 2006/0218978 A1
(43) Pub. Date: Oct. 5, 2006

(54) Luggage strap lock and identifier and method therefor

(76) Inventors: Debra J. Toler, Glendale, AZ (US); Robert Z. Toler, Glendale, AZ (US)

Correspondence Address: WEISS & MOY PC, 4204 NORTH BROWN AVENUE, SCOTTSDALE, AZ, 85251, US

(21) Appl. No.: 11/093,385

(22) Filed: Mar. 30, 2005

(51) Int. Cl. E05B 73/00

(52) U.S. Cl. 70/18

(57) ABSTRACT

A strap and closing assembly has a body section. The body section is in a shape of a torso. A head member is coupled to a top area of the body section. A first pair of straps is provided and has a first strap member having a first and second end and a second strap member having a first and second end. The first ends of the first and second strap members are coupled to a top area of the body section. The first pair of straps is in a shape of first appendages for the torso. A second pair of straps is provided and has a third strap member having a first and second end and a forth strap member having a first and second end. The first ends of the third and forth strap members are coupled to a bottom area of the body section. The second pair of straps is in a shape of second appendages for the torso. An attachment device is coupled to the first pair of straps and to the second pair of straps for coupling the first pair of straps to the second pair of straps when the first pair of straps and the second pair of straps are wrapped around the luggage.

### BACKGROUND OF THE INVENTION

1. Field of the Invention

This invention relates generally to luggage and, more particularly, to a strap and lock assembly for a piece of luggage which can be used to prevent individuals from accessing the luggage and which further may be used to help one identify his/her own piece of luggage from a similar looking one.

2. Description of the Prior Art

It is common knowledge that luggage is often the objects of thieves. Baggage handlers working for the different companies in the transportation industry have been known to open the luggage of passengers and to steal valuable items stored inside. Furthermore, many individuals have had items stolen from inside their unlocked luggage when they leave their luggage unattended or when carrying their luggage and are inattentive to those around them.

Another common problem encountered by travelers is the rough handling of baggage on airplanes, trains, ships, buses, and the like. Rough handling often causes unintended opening of the luggage or causes a portion of the luggage to burst open and expose the contents to dirt, destruction, or theft.

Because of the above problems, different types of straps and locks for luggage have been developed. Many pieces of luggage have a lock built directly into the carrying department of the piece of luggage. Other pieces of luggage use a strap and lock assembly. While both of the above systems work, they all have one main problem. All of the luggage lock systems basically look the same. Thus, when the luggage is unloaded by baggage handlers working for the different companies in the transportation industry, one is generally unable to locate his/her luggage since many pieces of luggage are similar looking.

Therefore, a need existed to provide an improved strap and lock assembly for a piece of luggage which overcomes the problems associated with prior art luggage lock systems. The improved strap and lock assembly for a piece of luggage must be able to prevent individuals from accessing the luggage. The improved strap and lock assembly for a piece of luggage must further be able to be used to help one identify his/her own piece of luggage from a similar looking one.

### SUMMARY OF THE INVENTION

In accordance with one embodiment of the present invention, it is an object of the present invention to provide an improved strap and lock assembly for a piece of luggage which overcomes the problems associated with prior art luggage lock systems.

It is another object of the present invention to provide an improved strap and lock assembly for a piece of luggage that is able to prevent individuals from accessing the luggage.

It is yet another object of the present invention to provide an improved strap and lock assembly for a piece of luggage that is able to be used to help one identify his/her own piece of luggage from a similar looking one.

### BRIEF DESCRIPTION OF THE EMBODIMENTS

In accordance with one embodiment of the present invention, a strap and closing assembly for luggage is disclosed. The strap and closing assembly has a body section. The body section is in a shape of a torso. A head member is coupled to a top area of the body section. A first pair of straps is provided and has a first strap member having a first and second end and a second strap member having a first and second end. The first ends of the first and second strap members are coupled to a top area of the body section. The first pair of straps is in a shape of first appendages for the torso. A second pair of straps is provided and has a third strap member having a first and second end and a forth strap member having a first and second end. The first ends of the third and forth strap members are coupled to a bottom area of the body section. The second pair of straps is in a shape of second appendages for the torso. An attachment device is coupled to the first pair of straps and to the second pair of straps for coupling the first pair of straps to the second pair of straps when the first pair of straps and the second pair of straps are wrapped around the luggage.

In accordance with another embodiment of the present invention, a strap and closing assembly for luggage is disclosed. The strap and closing assembly has a body section. The body section is in a shape of a torso. A head member is coupled to a top area of the body section. A first pair of straps having a first strap member having a first and second end and a second strap member having a first and second end is provided. The first ends of the first and second strap members are coupled to a top area of the body section. The first strap member and the second strap member extend out and away from the body section for a predefined distance. The first strap member and the second strap member then run parallel to one another. The second ends of the first strap member and the second strap member then come together. The first pair of straps is in a shape of first appendages for the torso. A second pair of straps having a third strap member having a first and second end and a forth strap member having a first and second end is provided. The first ends of the third and forth strap members are coupled to a bottom area of the body section. The third strap member and the forth strap member extend out and away from the body section for a predefined distance. The third strap member and the forth strap member then run parallel to one another. The second ends of the third strap member and the forth strap member come together. The second pair of straps is in a shape of second appendages for the torso. An attachment device is coupled to the first pair of straps and to the second pair of straps for coupling the first pair of straps to the second pair of straps when the first pair of straps and the second pair of straps are wrapped around the luggage.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings.

FIG. 1 is an elevated perspective view of a strap and lock assembly for a piece of luggage of the present invention.

FIG. 2 is an elevated perspective view of the strap and lock assembly for a piece of luggage as shown in FIG. 1 removed from the piece of luggage.

FIG. 3 is a front view of the locking mechanism used in the strap and lock assembly for a piece of luggage of the present invention.

FIG. 4 is a elevated view of another embodiment of the locking mechanism used in the strap and lock assembly for a piece of luggage of the present invention.

FIG. 5 is an elevated perspective view of another embodiment of the strap and lock assembly for a piece of luggage of the present invention.

### DETAILED DESCRIPTION OF THE PREFERRED EMBODIMENT

Referring to the Figures, a strap and lock assembly 10 for a piece of luggage 12 is shown. The strap and lock assembly 10 is used to prevent individuals from accessing the luggage and further may be used to help one identify his/her own piece of luggage from a similar looking one.

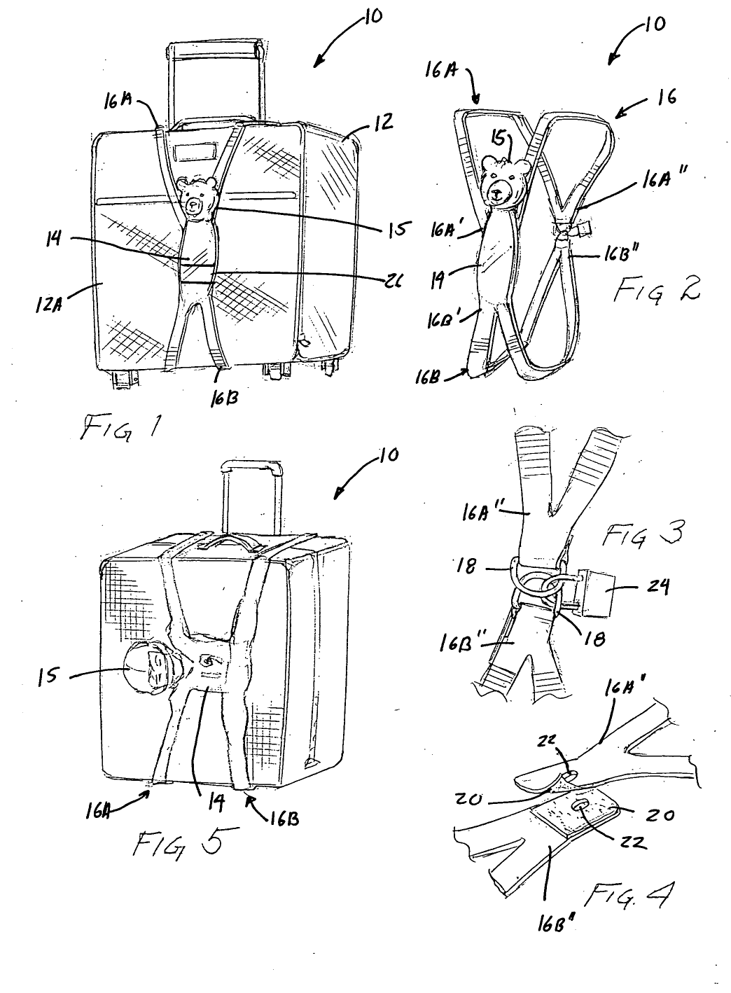

The strap and lock assembly 10 has a body section 14. The body section 14 is shaped like a torso. In order to provide a more lifelike impression, the body section 14 is slightly filled to provide a three dimensional appearance. As seen in FIG. 1, the body section 14 is shaped like a torso of an animal. The animal may be a bear, monkey, or the like. The above are just given as an example, and should not be seen as to limit the scope of the present invention. The body section 14 may take on other torso shapes as well. As may be seen in FIG. 5, the body section 14 is in the shape of a human body. The body section 14 may further be decorated to look more like an animal or a human torso.

A head 15 is coupled to the body section 14. The head 15 will take a form similar to that of the body section 14. Thus, if the body section is in the shape of an animal, the head 15 will also take the form of an animal. If the body section is in the shape of a human, the head 15 will also take the form of a human. The head 15, like the body section 14 is filled to provide a three dimensional appearance. The head 15 may further be decorated to look more like an animal or a human head.

Strap members 16 are coupled to the body section 14. The strap members 16 are used to wrap around the luggage 12 in order to prevent the lid 12A of the luggage 12 from opening. The strap members 16 may be made out of a stretchable resilient material so that the straps 16 can fit around different size luggage 12. For example, the straps 16 may be made out of an elastic material, a rubber material, or the like. Alternatively, the straps 16 may be made out of a stiffer non-stretching material, but will have an adjustment mechanism to adjust a length of each strap 16.

In the embodiments depicted in the Figures, a pair of straps 16A are coupled to an upper portion of the body section 14. The pair of straps 16A will have first ends 16A′ coupled to the body section 14. The straps 16A extend out and away from the body section 14. The straps 16A will then run parallel to one another. In accordance with one embodiment of the present invention, the second end 16A″ of the pair of straps 16A are angled towards each other so that the second end 16A″ of the pair of straps 16A come together. Alternatively, the second end 16A″ of the pair of straps 16A may continue to run parallel to one another.

Another pair of straps 16B are coupled to a lower portion of the body section 14. The pair of straps 16B will have first ends 16B′ coupled to a lower portion of the body section 14. The straps 16B extend out and away from the body section 14. The straps 16B will then run parallel to one another. In accordance with one embodiment of the present invention, a second end 16B″ of the pair of straps 16B are angled towards each other so that the second end 16B″ of the pair of straps 16B come together. Alternatively, the second end 16B″ of the pair of straps 16B may continue to run parallel to one another.

The straps 16 are formed in the shape of appendages to match the body section 14 which will take on a certain torso shape (i.e., human, animal, etc.). Thus, in FIG. 5, since the body section 14 is in the shape of a human torso, the pair of straps 16A coupled to the upper portion of the body section 14 are formed in a shape of a pair of arm members. Likewise, the pair of straps 16B coupled to a lower portion of the body section 14 are formed in the shape of a pair of leg members.

The straps 16 may be wrapped in different manners in order to secure the lid 12A from opening. As shown in FIG. 1, the straps 16 are wrapped over the top and around the bottom of the luggage 12. Alternatively, a pair of straps 16 can be wrapped over the top of the luggage 12 and a second pair of straps 16 may be wrapped around the side of the luggage 12.

Once the straps 16 are wrapped around the luggage 12, the straps 16 need to be coupled together. The straps 16 may be coupled together in a variety of different manners.

As shown in FIG. 3, the second end 16A″ of the pair of straps 16A and the second end 16B″ of the pair of straps 16B will have ring members 18 coupled thereto. If the second end 16A″ of the pair of straps 16A run parallel to one another, the second end 16A″ of each strap 16A will have a ring member 18. If the second ends 16A″ are angled towards each other so that the second end 16A″ of the pair of straps 16A are coupled together, then a single ring member 18 is used. In a like manner, if the second end 16B″ of the pair of straps 16B run parallel to one another, the second end 16B″ of each strap 16B will have a ring member 18. If the second ends 16B″ are angled towards each other so that the second end 16B″ of the pair of straps 16B are coupled together, then a single ring member 18 is used.

Alternatively, as shown in FIG. 4, hook and loop material 20 may be placed on the second ends 16A″ and 16B″ of the pair of straps 16A and 16B respectively. The hook portion of the hook and loop material 20 will be placed on one of the second ends 16A″ or 16B″. The loop material is then placed on the corresponding second end 16A″ or 16B″ which will be coupled to the first one of the second ends 16A″ or 16B″. If hook and loop material 20 is used, a small opening 22 may be formed in the second ends 16A″ and 16B″ of the pair of straps 16A and 16B.

A locking device 24 may be used to couple the pairs of straps 16A and 16B together. As shown in FIG. 3, if ring members 18 are used, the ring members 18 are brought together and the lock device 24 is used to couple the ring members 18 together. A pad lock, a combination lock, wire ties or the like may be used.

Referring back to FIG. 4, if hook and loop material 20 is placed on the second ends 16A″ and 16B″ of the pair of straps 16A and 16B, a locking device 24 may or may not be used. Since many governmental agencies are required to look through the luggage of all passengers prior ro boarding an airplane, train, bus, etc., many individuals do not lock their luggage 12. By using the hook and loop material 20, one may secure the strap and lock assembly 10 around the luggage 12 thereby preventing unintended opening of the luggage and exposing the contents to dirt, destruction, or theft.

If a locking device 24 is used with the hook and loop material 20, a small opening 22 may be formed in the second ends 16A″ and 16B″ of the pair of straps 16A and 16B. The locking device 24 is inserted through the opening 22 to secure the pair of straps 16A and 16B together. A pad lock, a combination lock, wire ties or the like may be used.

An identification tag 26 may be coupled to the strap and lock assembly 10. In accordance with one embodiment of the present invention, the identification tag 26 is coupled to the body section 14. However, the identification tag 26 may be placed on other areas of the strap and lock assembly 10 without departing from the spirit and scope of the present invention.

### Operation

In operation, the strap and lock assembly 10 is placed around the luggage 12 to prevent the lid 12A of the luggage from being opened. The straps 16 may be wrapped in different manners in order to secure the lid 12A from opening. As shown in FIG. 1, the straps 16 are wrapped over the top and around the bottom of the luggage 12. Alternatively, a first pair of straps 16A can be wrapped over the top of the luggage 12 and a second pair of straps 16B may be wrapped around the side of the luggage 12 or vice versa.

The body section 14 can be positioned in different manners on the luggage 12. As seen in FIG. 1, the body section 14 may be positioned in a vertical manner. Alternatively, the body section 14 may be positioned in a horizontal manner as shown in FIG. 5. The body section 14 may be positioned in any manner on the luggage 12 without departing from the spirit and scope of the present invention. In order to prevent damage to the body section 14 and head 15, the body section 14 and head 15 are generally positioned on the lid 12A of the luggage 12 as shown in FIGS. 1 and 5. However, the body section 14 and head 15 may be positioned on the luggage 12 so that the head 15 is above the luggage 12 or to the side of the luggage 12. This gives the appearance of the head 15 looking over the top or to the side of the luggage 12.

Once the first pair of straps 16A and the second pair of straps 16B are wrapped around the luggage 12, the first pair of straps 16A and the second pair of straps 16B are coupled together. A locking device 24 may be used to securely hold the first pair of straps 16A to the second pair of straps 16B.

The strap and lock assembly 10 for a piece of luggage 12 is useful to prevent the luggage lid 12A from inadvertently opening. For added security a locking device 24 may be used to prevent individuals from accessing the luggage. The body section 14 and head 15 provide a unique look to help a person identify his/her own piece of luggage from a similar looking one.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A strap and closing assembly for luggage comprising:
a body section wherein the body section is in a shape of a torso;
a head member coupled to a top area of the body section;
a first pair of straps having a first strap member having a first and second end and a second strap member having a first and second end, wherein first ends of the first and second strap members are coupled to a top area of the body section, the first pair of straps is in a shape of first appendages for the torso;
a second pair of straps having a third strap member having a first and second end and a forth strap member having a first and second end, wherein the first ends of the third and forth strap members are coupled to a bottom area of the body section, the second pair of straps is in a shape of second appendages for the torso; and
an attachment device coupled to the first pair of straps and to the second pair of straps for coupling the first pair of straps to the second pair of straps when the first pair of straps and the second pair of straps are wrapped around the luggage.

2. A strap and closing assembly for luggage in accordance with claim 1 further comprising a locking device to secure the first pair of straps to the second pair of straps.

3. A strap and closing assembly for luggage in accordance with claim 1 wherein the first pair of straps and the second pair of straps are made of a resilient material.

4. A strap and closing assembly for luggage in accordance with claim 1 wherein the first strap member and the second strap member extend out and away from the body section for a predefined distance, the first strap member and the second strap member then running parallel to one another.

5. A strap and closing assembly for luggage in accordance with claim 4 wherein the second ends of the first strap member and the second strap member come together.

6. A strap and closing assembly for luggage in accordance with claim 5 wherein the attachment device is a ring coupled to the second ends of the first strap member and the second strap member.

7. A strap and closing assembly for luggage in accordance with claim 1 wherein the third strap member and the forth strap member extend out and away from the body section for a predefined distance, the third strap member and the forth strap member then running parallel to one another.

8. A strap and closing assembly for luggage in accordance with claim 7 wherein the second ends of the third strap member and the forth strap member come together.

9. A strap and closing assembly for luggage in accordance with claim 8 wherein the attachment device is a ring coupled to the second ends of the third strap member and the forth strap member.

10. A strap and closing assembly for luggage in accordance with claim 1 wherein the attachment device is hook and loop material coupled to the first pair of straps and to the second pair of straps.

11. A strap and closing assembly for luggage in accordance with claim 10 wherein openings are formed in the first pair of straps, the second pair of straps, and the hook and loop material for securing a locking device to the first pair of straps and to the second pair of straps.

12. A strap and closing assembly for luggage comprising:
a body section wherein the body section is in a shape of a torso;
a head member coupled to a top area of the body section;
a first pair of straps having a first strap member having a first and second end and a second strap member having a first and second end, the first ends of the first and second strap members are coupled to a top area of the body section, the first strap member and the second strap member extending out and away from the body section for a predefined distance, the first strap member and the second strap member then running parallel to one another, the second ends of the first strap member and the second strap member then coming together, the first pair of straps is in a shape of first appendages for the torso;
a second pair of straps having a third strap member having a first and second end and a forth strap member having a first and second end, the first ends of the third and forth strap members are coupled to a bottom area of the body section, the third strap member and the forth strap member extending out and away from the body section for a predefined distance, the third strap member and the forth strap member of the second pair of straps then running parallel to one another, the second ends of the third strap member and the forth strap member coming together, the second pair of straps is in a shape of second appendages for the torso; and
an attachment device coupled to the first pair of straps and to the second pair of straps for coupling the first pair of straps to the second pair of straps when the first pair of straps and the second pair of straps are wrapped around the luggage.

13. A strap and closing assembly for luggage in accordance with claim 12 wherein the attachment device comprises:
a first ring coupled to the second ends of the first strap member; and
a second ring coupled to the second ends of the third strap member and the forth strap member.

14. A strap and closing assembly for luggage in accordance with claim 13 further comprising a locking device to secure the first ring to the second ring.

15. A strap and closing assembly for luggage in accordance with claim 12 wherein the first pair of straps and the second pair of straps are made of a resilient material.

16. A strap and closing assembly for luggage in accordance with claim 12 wherein the attachment device is hook and loop material coupled to the second ends of the first strap member, the second strap member, the third strap member and the forth strap member.

17. A strap and closing assembly for luggage in accordance with claim 16 wherein openings are formed in the first pair of straps, the second pair of straps, and the hook and loop material for securing a locking device to the first pair of straps and to the second pair of straps.

18. A strap and closing assembly for luggage comprising:
a body section wherein the body section is in a shape of a torso;
a head member coupled to a top area of the body section;
a first pair of straps having a first strap member having a first and second end and a second strap member having a first and second end, the first ends of the first and second strap members are coupled to a top area of the body section, the first strap member and the second strap member extending out and away from the body section for a predefined distance, the first strap member and the second strap member then running parallel to one another, the second ends of the first strap member and the second strap member then coming together, the first pair of straps is in a shape of first appendages for the torso;
a second pair of straps having a third strap member having a first and second end and a forth strap member having a first and second end, the first ends of the third and forth strap members are coupled to a bottom area of the body section, the third strap member and the forth strap member extending out and away from the body section for a predefined distance, the third strap member and the forth strap member of the second pair of straps then running parallel to one another, the second ends of the third strap member and the forth strap member coming together, the second pair of straps is in a shape of second appendages for the torso; and
an attachment device coupled to the first pair of straps and to the second pair of straps for coupling the first pair of straps to the second pair of straps when the first pair of straps and the second pair of straps are wrapped around the luggage, wherein the attachment device is hook and loop material coupled to the first pair of straps and to the second pair of straps.

19. A strap and closing assembly for luggage in accordance with claim 18 wherein the first pair of straps and the second pair of straps are made of a resilient material.
